(19) United States
(12) Patent Application Publication
(10) Pub. No.: US 2013/0346033 A1
(43) Pub. Date: Dec. 26, 2013

(54) TREE-BASED REGRESSION

(71) Applicants: Jianqiang Wang, Mountain View, CA (US); Kay-Yut Chen, Santa Clara, CA (US); Enis Kayis, East Palo Alto, CA (US); Guillermo Gallego, Waldwick, NJ (US); Jose Luis Beltran Guerrero, Mountain View, CA (US); Ruxian Wang, Mountain View, CA (US); Shailendra K. Jain, Cupertino, CA (US)

(72) Inventors: Jianqiang Wang, Mountain View, CA (US); Kay-Yut Chen, Santa Clara, CA (US); Enis Kayis, East Palo Alto, CA (US); Guillermo Gallego, Waldwick, NJ (US); Jose Luis Beltran Guerrero, Mountain View, CA (US); Ruxian Wang, Mountain View, CA (US); Shailendra K. Jain, Cupertino, CA (US)

(21) Appl. No.: 13/528,972

(22) Filed: Jun. 21, 2012

(51) Int. Cl. G06F 17/10

(52) U.S. Cl. CPC G06F 17/10; G06Q 30/0206
USPC 703/2

(57) ABSTRACT

Parent node data is split into first and second child nodes based on a first partition variable to create a tree-based model. A first regression model for the first child node data relates the response variable and the predictor variable.

### BACKGROUND

Varying-coefficient regression models often yield superior fits to empirical data by allowing parameters to vary as functions of some environmental variables. Very often in varying-coefficient models, the coefficients have an unknown functional form which is estimated nonparametrically. However, such varying-coefficient models with a large number of mixed-type varying-coefficient variables tend to be challenging for conventional nonparametric smoothing methods.

### BRIEF DESCRIPTION OF THE DRAWINGS

FIG. 1 is a block diagram illustrating an example of a pricing system.

FIG. 2 is a block diagram illustrating an example of a computer system.

FIG. 3 is a flow diagram illustrating an example of a tree-based modeling method.

FIGS. 4-6 are examples of tree based models.

FIG. 7 is an example plot of sales units against price.

FIG. 8 is an example plot of log-transformed sales units against price.

FIG. 9 illustrates L₂ risk on training and test sample data.

### DETAILED DESCRIPTION

In the following detailed description, reference is made to the accompanying drawings which form a part hereof, and in which is shown by way of illustration specific embodiments in which the invention may be practiced. It is to be understood that other implementations may be utilized and structural or logical changes may be made without departing from the scope of the present invention. The following detailed description, therefore, is not to be taken in a limiting sense, and the scope of the present invention is defined by the appended claims. It is to be understood that features of the various embodiments described herein may be combined with each other, unless specifically noted otherwise.

Estimating the aggregated market demand for a product in a dynamic market is intrinsically important to manufacturers and retailers. The historical practice of using business expertise to make decisions is subjective, irreproducible and difficult to scale up to a large number of products. The disclosed systems and methods provide a scientifically sound approach to accurately price a large number of products while offering a reproducible and real-time solution.

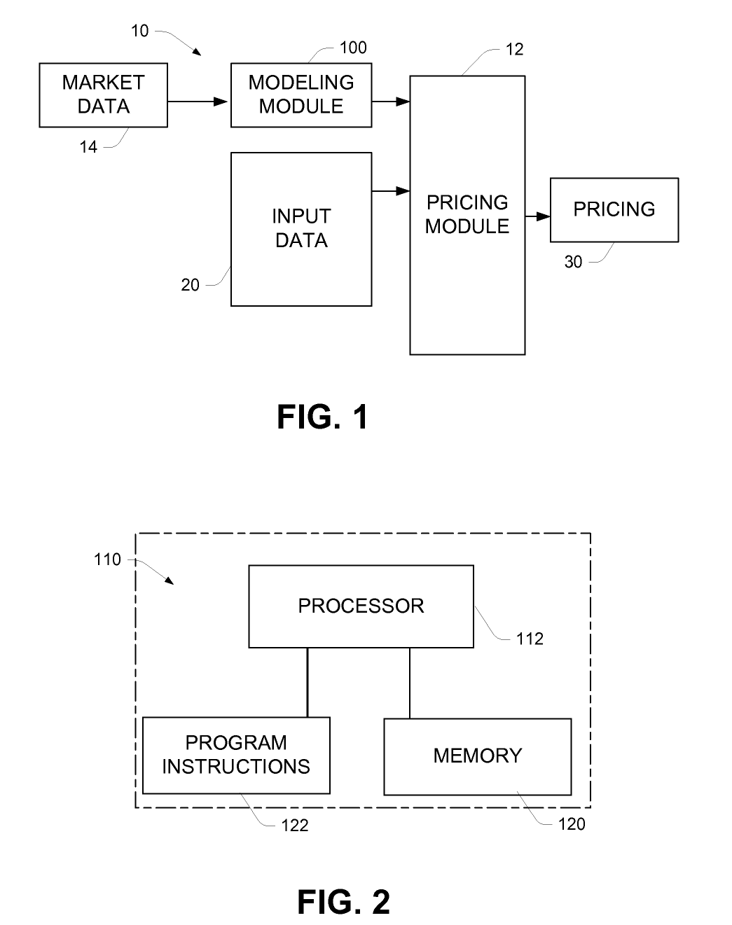

FIG. 1 conceptually illustrates an example of a pricing system in accordance with certain teachings of the present disclosure. For instance, when setting prices for products it is desirable to assign prices to achieve a desired sales volume, market share, etc. In the system 10 of FIG. 1, a pricing module 12 receives input data 20 and based thereon, outputs optimal product pricing 30. In some implementations, the inputs 20 include information regarding product costs, business objectives, component availability, inventory, etc. The pricing module 12 is configured to optimize certain business criteria, such as profit, under various constraints such as market share, component availability, inventory, etc.

Further input to the pricing module 12 is provided by a modeling module 100. The modeling module 100 receives historical market data 14, for example, and uses the market data 14 to calculate prediction models for the pricing module 12. In some implementations, an estimate of the aggregated market demand is used by the pricing module 12 in determining product pricing 30. Thus, in the illustrated example system 10, the modeling module 100 is configured to calculate a demand prediction model that quantifies product demand under different price points for each product based on the historical market data 14.

FIG. 2 illustrates a block diagram of an example of a computer system 110 suitable for implementing various portions of the system 10, including the modeling module 100. The computer system 110 includes a processor 112 coupled to a memory 120. The memory 120 can be operable to store program instructions 122 that are executable by the processor 112 to perform one or more functions of the modeling module 100 and/or the pricing module 12. It should be understood that “computer system” can be intended to encompass any device having a processor that can be capable of executing program instructions from a memory medium. In certain implementations, the various functions, processes, methods, and operations described herein may be implemented using the computer system 110.

The various functions, processes, methods, and operations performed or executed by the system 10 and modeling module 100 can be implemented as the program instructions 122 (also referred to as software or simply programs) that are executable by the processor 112 and various types of computer processors, controllers, central processing units, microprocessors, digital signal processors, state machines, programmable logic arrays, and the like. In some implementations, the computer system 110 may be networked (using wired or wireless networks) with other computer systems, and the various components of the system 110 may be local to the processor 112 or coupled thereto via a network.

In various implementations the program instructions 122 may be stored in the memory 120 or any non-transient computer-readable medium for use by or in connection with any computer-related system or method. A computer-readable medium can be an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

In certain implementations, the modeling module 100 is configured to model demand as a function of price (e.g., linear regression), but allow the model parameters to vary with product features and other variables. Varying-coefficient regression models often yield superior fits to empirical data by allowing parameters to vary as functions of some environmental variables. Very often in varying-coefficient models, the coefficients have unknown functional form which is estimated nonparametrically.

In systems where the modeling module 100 is configured to predict demand, there can be many varying-coefficient variables with mixed types. Specifically, in predicting product demand, the variables can include various product features and environmental variables like time and location. The regression coefficients are thus functions of high-dimensional covariates, which need to be estimated based on data. Here, the interaction among product features is complex. It is unrealistic to assume that their effects are additive, and it is difficult to specify a functional form that characterizes their joint effects on the regression parameters. Given these practical constraints, the modeling module 100 is configured to provide a data-driven approach for estimating high-dimensional non-additive functions.

Classification and regression trees (“CART”) refers to a tree-based modeling approach used for high-dimensional classification and regression. Such tree-based methods handle the high-dimensional prediction problems in a scalable way and incorporate complex interactions. Single-tree based learning methods, however, tend to be unstable, and a small perturbation to the data may lead to a dramatically changed model.

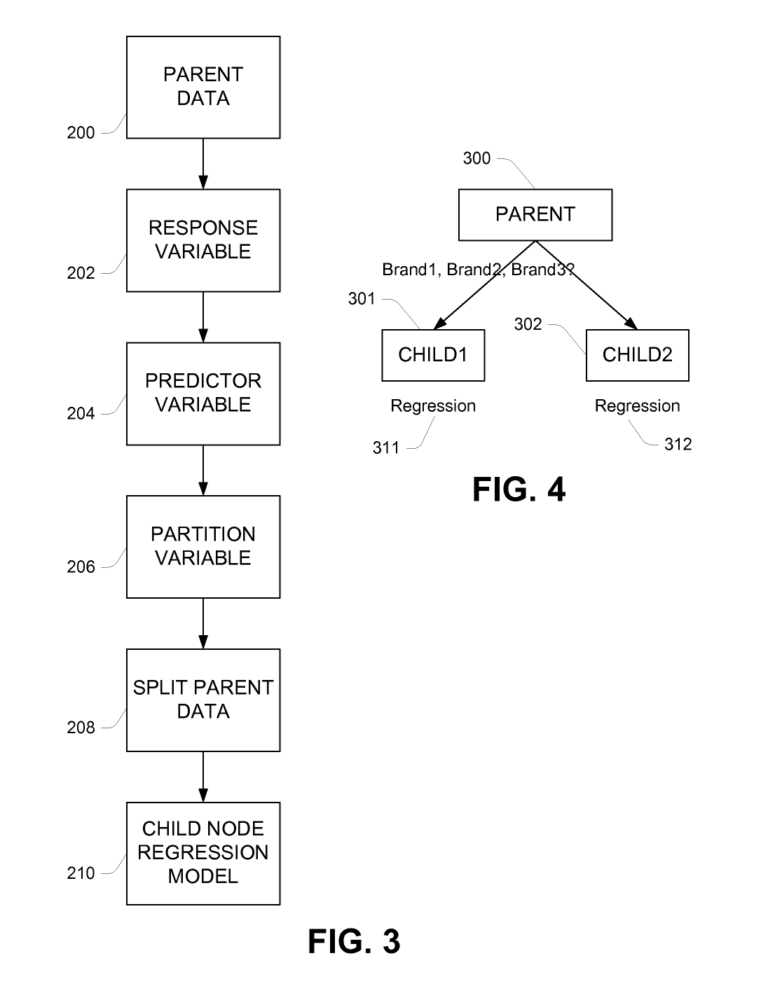

FIG. 3 conceptually illustrates an example of a method for creating a tree-based model implemented by the modeling module 100. Data for building the model, such as historical sales and product configuration data, is provided in block 200 and can be stored, for example, in the memory 120. To build the tree-based model, the provided data 200 are subsequently split into child nodes, so the information provided in block 200 is referred to as parent node data. In block 202, a response variable is specified and in block 204 a predictor variable is specified. In the example system illustrated in FIG. 1, the modeling module 100 is configured to calculate a demand prediction model that quantifies product demand under different price points. Thus, in that example, the response variable is sales volume or some other measure of product demand and the predictor variable is price. The varying-coefficient variables are referred to herein as partition variables, since the data splits or partitions that create the child data nodes are determined based on these variables. In block 206, a first partition variable is determined, and in block 208 the parent node data is split into first and second child nodes based on the first partition variable to create the tree-based model. A regression model is created for the first child node data that relates the response variable and the predictor variable in block 210.

FIGS. 4-6 illustrate examples of tree-based models. FIG. 4 illustrates an example having a parent node 300 that is split into first and second child nodes 301, 302. A child node that is not split into further nodes is referred to as a leaf node or terminal node, which defines the ultimate data grouping. In the tree-based models disclosed herein, each terminal node has a regression model for the included data that relates the response variable and predictor variable. In the model of FIG. 4, each of the child nodes 301,302 is a terminal node. For example, the regression models 311,312 could be linear regressions relating product demand to price.

In terms of the pricing system example illustrated in FIG. 1, the model input to the pricing module 12 from the modeling module 100 could be a tree-based model, such as those illustrated in FIGS. 4-6, for predicting product demand based on price. Such a model is determined based on historical market data 14. In the tree-based models illustrated in FIGS. 4-6, the response variable is product demand and the predictor variable is product price. In FIG. 4, there is a single partition variable upon which splitting the parent node 300 into the child nodes 301, 302 is based. For purposes of illustration, the response variable in FIG. 4 is brand. For example, if there were five available brands, brand1 . . . brand 5, the split could be based on grouping the first three brands and the last two. The first regression model 311 thus relates demand and price for data including the first three brands and the second regression model 312 relates demand and price for data including the fourth and fifth brands.

In certain implementations, the particular partitioning or splitting of the parent data 300 based on the partition variable is determined by evaluating several possible data splits. In FIG. 4, the parent node is split into two child nodes. For example, each possible split could be evaluated by creating a regression model for the parent node data 300 and determining an error value for the parent regression model, and creating regression models and associated error values for each of the child nodes. The child node errors are compared to the parent node error value to determine the split that minimizes the error value. Detailed examples of determining the data partitioning are discussed further herein below.

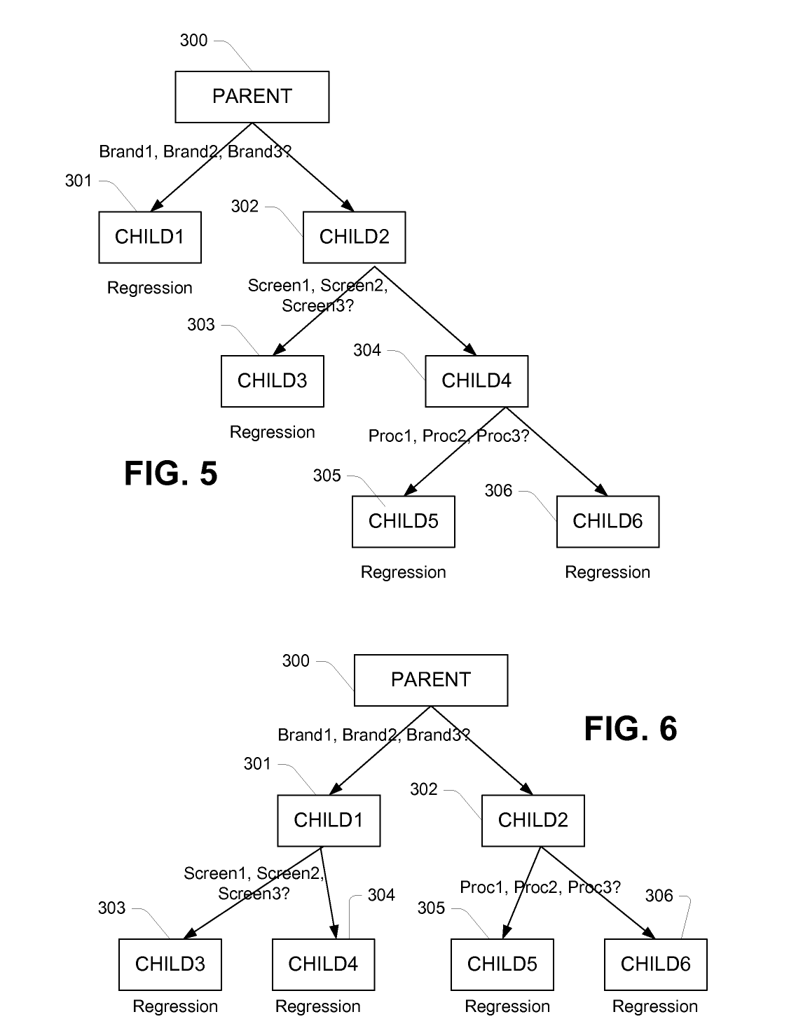

FIG. 5 illustrates another example of a tree-based model in which the parent node 300 is split into two child nodes 301,302, with the first child node 301 being a terminal node and having a first regression model relating the response and predictor variables. The second child node 302 is further split into third and fourth child nodes 303, 304 based on another partition variable. In the example illustrated in FIG. 5, the parent node data 300 are split based on a first partition variable, brand. The second child node 302 is then split into the further child nodes 303,304 based on a second partition variable. For example, if the product under consideration were laptop computers, the first partition variable would be the laptop computer brand, and the second partition variable could be the screen size of the laptop computer.

In FIG. 5, the child node 304 is further split into two more child nodes 305,306 based on a third partition variable, such as processor type. In the example of FIG. 5, the fifth and sixth child nodes 305,306 are both terminal nodes, and include regression models relating the response and predictor variables demand and price, respectively. As shown in FIG. 5, building the tree-based model is an iterative process, where the parent node is split, and certain child nodes are subsequently split to create a series of nested trees. In some implementations, this process is repeated until some predetermined number of terminal nodes is reached. Example processes for determining the tree size (number of terminal nodes) are disclosed in further detail herein below. As noted above, the data partitioning or splitting process is based on several partition variables in the example of FIG. 5. Choosing the particular partition variable for each of the data splits is based, for example, on a relationship between a given partition variable and the response variable. Example processes for determining partition variables are disclosed in further details herein below.

FIG. 6 illustrates another example where the parent node 300 is split into two child nodes 301, 302, neither of which is a terminal node. The parent node is split based on a first partition variable (brand in this example). The child nodes are spit based on respective second and third partition variables in FIG. 6. Thus, the first child node is split into two child nodes 303,304 based on processor type as the second partition variable, and the second child node 302 is split into two more child nodes 305,306 based on screen size as the third partition variable. In the example of FIG. 6, each of the child nodes 303,304,305,306 is a terminal node, each having a regression model associated therewith.

Referring back to FIG. 1, the modeling module 100 thus is configured to provide a tree-based model such as the examples illustrated in FIGS. 4-6 based on historical market data 14. The model is input to the pricing module 30 along with the inputs 20 to determine optimum pricing. For instance, if the tree-based demand model illustrated in FIG. 5 were provided from the modeling module 100 to the pricing module 30, inputs 20 would include brand, since brand was a partition variable used in creating the model. The particular child node 301 or 302 is chosen by the processor 112 (or other appropriately configured processor) based on the brand, and the regression model associated with the selected child node is used to predict demand based on price.

Additional aspects of the disclosed systems and methods are described in further detail as follows. For example, let y be the response variable 202, xεR^{p} denote the vector of predictors 204 that a parametric relationship is available between y and x, for any given values of the varying coefficient, or partition variable vector sεR^{q}, where p and q are the number of predictor variables and partition variables, respectively. The regression relationship between y and x varies under different values of s. The idea of partitioning the space of varying coefficient, or partition variables s, and then imposing a parametric form familiar to the subject matter area within each partition conforms with the general notion of conditioning on the partition variables s. Let (s′ᵢ, x′ᵢ, yᵢ) denote the measurements on subject i, where i=1, . . . , n, and n is the number of subjects. Here, the partition variable sᵢ=(sᵢ₁, s₁₂, . . . , s_{iq})′ and the regression variable xᵢ=(xᵢ₁, xᵢ₂, . . . , xᵢₚ)′, and overlap is allowed between the two sets of variables. The varying-coefficient linear model specifies that,

yᵢ=f(xᵢ,sᵢ)+εᵢ=x′ᵢβ(sᵢ)+εᵢ, (1)

where the regression coefficients β(sᵢ) are modeled as functions of s.

In model (1), the key interest is to estimate the multivariate coefficient surface β(sᵢ). The disclosed estimation method allows for a high-dimensional varying-coefficient vector sᵢ. Examples of the tree-based method approximate β(sᵢ) by a piecewise constant function. An example of the proposed tree-based varying-coefficient model is,

$${y}_{i} = {x}_{i}^{′} {\sum }_{m = 1}^{M} {π}_{m} ( {s}_{i} ) {β}_{m} + {ε}_{i} , \qquad ( 2 )$$

where πₘ(sᵢ)ε{0, 1} with

Σₘ₌₁^{M}πₘ(s)=1

for any sεR^{q}. The error terms εᵢ are assumed to have zero mean and homogeneous variance σ². The disclosed method can be readily generalized to models with heterogeneous errors. The M-dimensional vector of weights π(s)=(π₁(s), π₂(s), . . . , π_{M}(s)) is regarded as a mapping from sεR^{q} to the collection of K-tuples

$$\{ ( {π}_{1} , {π}_{2} , … , {π}_{M} ) \vert {\sum }_{m = 1}^{M} {π}_{m} = 1 and {π}_{m} ∈ \{ 0 , 1 \} \} . \qquad ( 3 )$$

The partitioned regression model (2) can be treated as an extension of regression trees which boils down to the ordinary regression tree if the vector of regression variable only includes 1.

The collection of binary variables πₘ(s) defines a partition of the space R^{q}. Cₘ={s|πₘ(s)=1}, and the constraints in (3) are equivalent to Cₘ∩C_{m′}=ø for any m≠m′, and U^{M}ₘ₌₁Cₘ=R^{q}. Hence the partitioned regression model (2) can be reformulated as

$${y}_{i} = {x}_{i}^{′} {\sum }_{m = 1}^{M} {x}_{i}^{′} {β}_{m} {I}_{( {s}_{i} ∈ {C}_{m} )} + {ε}_{i} , \qquad ( 4 )$$

where I_{(.)} denotes the indicator function with I_{(c)}=1 if event c is true and zero otherwise. The implied varying-coefficient function is thus

$$β ( {s}_{i} ) \approx {\sum }_{m = 1}^{M} {β}_{m} {I}_{( {s}_{i} ∈ {C}_{m} )} ,$$

a piecewise constant function in R^{q}. In the terminology of recursive partitioning, the set Cₘ is a child data node referred to as a terminal node or leaf node, which defines the ultimate grouping of the observations (for example, first and second child nodes 301, 302 in FIG. 4). The number of terminal nodes M is unknown, as well as the partitions {Cₘ}^{M}ₘ₌₁. In its fullest generality, the estimation of model (4) requires the estimation of M, Cₘ and βₘ simultaneously. The number of components M is difficult to estimate and could either be tuned via out-of-sample goodness-of-fit criteria or automatically determined by imposing certain rules in model fitting.

Before addressing the determination of M, the estimation of partition and regression coefficients is considered. The usual least squares criterion for (4) leads to the following estimators of (Cₘ, βₘ), as minimizers of sum of squared errors (SSE),

$$( {{C}^{⋒}}_{m} , {\hat{β}}_{m} ) = {arg min}_{( {C}_{m} , {β}_{m} )} {\sum }_{i = 1}^{n} {( {y}_{i} - {\sum }_{m = 1}^{M} {x}_{i}^{′} {β}_{m} {I}_{( {s}_{i} ∈ {C}_{m} )} )}^{2} = {arg min}_{( {C}_{m} , {β}_{m} )} {\sum }_{i = 1}^{n} {\sum }_{m = 1}^{M} {( {y}_{i} - {x}_{s}^{′} {β}_{m} )}^{2} {I}_{( {s}_{i} ∈ {C}_{m} )} . \qquad ( 5 )$$

In the above, the estimation of βₘ is nested in that of the partitions. \hat{β}ₘ(Cₘ) is a consistent estimator of βₘ given the partitions. The estimator could be a least squares estimator, maximum likelihood estimator, or an estimator defined by estimating equations. The following least squares estimator is an example

$${\hat{β}}_{m} = {arg min}_{{β}_{m}} {\sum }_{i = 1}^{n} {( {y}_{i} - {x}_{i}^{′} {β}_{m} )}^{2} {I}_{( {s}_{i} ∈ {C}_{m} )} ,$$

in which the minimization criterion is essentially based on the observations in node Cₘ only. Thus, the regression parameters βₘ are “profiled” out to have

$${{C}^{⋒}}_{m} = {arg min}_{{C}_{m}} {\sum }_{i = 1}^{n} SSEC ( {C}_{m} ) := {arg min}_{{C}_{m}} {\sum }_{i = 1}^{n} {\sum }_{m = 1}^{M} {( {y}_{i} - {x}_{i}^{′} {\hat{β}}_{m} ( {C}_{m} ) )}^{2} {I}_{( {s}_{i} ∈ {C}_{m} )} , \\ where \\ SSE ( {C}_{m} ) := {arg min}_{{C}_{m}} {\sum }_{i = 1}^{n} {( {y}_{i} - {x}_{i}^{′} {\hat{β}}_{m} )}^{2} {I}_{( {s}_{i} ∈ {C}_{m} )} . \qquad ( 6 )$$

By definition, the sets Cₘs comprise an optimal partition of the space expanded by the partitioning variables s, where the “optimality” is with respect to the least squares criterion. The search for the optimal partition is of combinatorial complexity, and it is of great challenge to find the globally optimal partition even for a moderate-sized dataset. The tree-based algorithm is an approximate solution to the optimal partitioning and scalable to large-scale datasets. For simplicity, the present disclosure focuses on implementations having binary trees that employ “horizontal” or “vertical” partitions of the feature space and are stage-wise optimal. As noted above, alternative implementations are envisioned where data are partitioned in to more than two child nodes.

An example tree-growing process, referred to herein as the iterative “Part Reg” process, adopts a breadth-first search and is disclosed in the following pseudo code.

Require: n₀—the minimum number of observations in a terminal node and M—the desired number of terminal nodes.

1. Initialize the current number of terminal nodes l=1 and Cₘ=R_{q}.

2. While l<M, loop:
(a) For m=1 to l and j=1 to q, repeat:
   i. Consider all partitions of Cₘ into C_{m,L} and C_{m,R} based on the j-th variable. The maximum reduction in SSE is,

ΔSSE_{m,j}=max{SSE(Cₘ)−SSE(C_{m,L})−SSE(C_{m,R})},
where the maximum is taken over all possible partitions based on the j-th variable such that min{#C_{m,L}, #C_{m,R}}≧n₀ and #C denotes the cardinality of set C.
ii. Let ΔSSEₗ=maxₘ maxⱼ ΔSSE_{m,j}, namely the maximum reduction in the sum of squared error among all candidate splits in all terminal nodes at the current stage.
(b) Let ΔSSE_{m*,j*}=ΔSSEₗ, namely the j*-th variable on the m*-th terminal node provides the optimal partition. Split the m*-th terminal node according to the optimal partitioning criterion and increase l by 1.

The breadth-first search cycles through all terminal nodes at each step to find the optimal split, and stops when the number of terminal nodes reaches the desired value M. The reduction of SSE is used as a criterion to decide which variable to split on. For a single tree, the stopping criterion is either the size of the resulting child node is smaller than the threshold n₀ or the number of terminal nodes reaches M. The minimum node size n₀ needs to be specified with respect to the complexity of the regression model, and should be large enough to ensure that the regression function in each node is estimable with high probability. The number of terminal nodes M, which is a measure of model complexity, controls the “bias-variance tradeoff.”

In the example tree growing process disclosed above, the modeling module 100 is configured to cycle through the partition variables at each iteration and consider all possible binary splits based on each variable. The candidate split depends on the type of the variable. For an ordered or a continuous variable, the distinct values of the variable are sorted, and “cuts” are placed between any two adjacent values to form partitions. Hence for an ordered variable with L distinct values, there are L−1 possible splits, which can be huge for a continuous variable in a large-scale data. Thus a threshold L_{cont} (500, for instance) is specified, and only splits at the L_{cont} equally spaced quantities of the variable are considered if the number of distinct values exceeds L_{cont}+1. An alternative way of speeding up the calculation is to use an updating algorithm that “updates” the regression coefficients as the split point is changed, which is computationally more efficient than having to recalculate the regression every time. The example disclosed above adopts the former approach for its algorithmic simplicity.

Three examples of methods for splitting data, such as illustrated in block 208 of FIG. 3, are considered as follows, including exhaustive search, category ordering and gradient descent:

1. Exhaustive search. All possible partitions of the factor levels into two disjoint sets are considered. For a categorical variable with L categories, an exhaustive procedure will attempt 2^{L-1}−1 possible splits.

2. Category ordering. The exhaustive search is computationally intensive for a categorical variable with a large number of categories. Thus the categories are ordered to alleviate the computational burden. In the partitioned regression context, let \hat{β}ₗ denote the least squares estimate of β based on observations in the l-th category. The fitted model in the l-th category is denoted x′\hat{β}ₗ. A strict ordering of the x′\hat{β}ₗs as functions of x may not exist, thus an approximate solution is used in some implementations. The L categories are ordered using x̅′\hat{β}ₗ, where x̅ is the mean vector of xᵢs in the current node, and the categorical variable is treated as ordinal. This approximation works well when the fitted models are clearly separated, but is not guaranteed to provide an optimal split at the current stage.

3. Gradient descent. The idea of ordering the categories ignores any partitions that do not conform with the current ordering, and is not guaranteed to reach a stage-wise optimal partition. A third process starts with a random partition of the L categories into two nonempty and non-overlapping groups, then cycles through all the categories and flips the group membership of each category. The L group assignments resulting from flipping each individual category are compared in terms of the reduction in SSE. The grouping that maximizes the reduction in SSE is chosen as the current assignment, and iteration continues until the algorithm converges. This algorithm performs a gradient descent on the space of possible assignments, where any two assignments are considered adjacent or reachable if they differ only by one category. The gradient descent algorithm is guaranteed to converge to a local optimum, thus multiple random starting points can be chosen in the hope of reaching the global optimal. If the criterion is locally convex near the initial assignment, then this search algorithm has polynomial complexity in the number of categories.

Two strategies, the default algorithm which combines the exhaustive search, gradient descent and category ordering, and an ordering approach that always orders the categories are used in certain implementations:

Default. In the default tree growing algorithm, a lower and an upper bound on the number of categories are specified, namely Lₘᵢₙ and Lₘₐₓ. When the number of categories is less than or equal to the lower bound, an exhaustive search is performed; when Lₘᵢₙ<L≦Lₘₐₓ, gradient descent is performed with a random starting point; and when the number of categories is beyond Lₘₐₓ, the categories are ordered and variable is treated as ordinal. Example implementations use this tree growing algorithm with Lₘᵢₙ=5 and Lₘₐₓ=40.

Ordering. In the ordering approach, the categorical variable is ordered irrespective of the number of categories (i.e., Lₘₐₓ=2). The ordering approach is much faster than the default algorithm.

At every stage of the tree, the algorithm cycles through the partition variables to find the optimal splitting variable (block 206 of FIG. 3, for example). The number of possible splits can differ dramatically for different types of variables and splitting methods. For continuous and ordinal variables, the number of possible splits depends on the number of distinct values, capped by L_{cont}; while for categorical variables, this number is exponential in the number of categories under exhaustive search, and linear if the variable is ordered. The number of attempted splits varies from one variable to another, which introduces bias in the selection of which variable to split on. Usually, variables that afford more splits, especially categorical variables with many categories, are favored by the algorithm. Category ordering can alleviate this issue, reducing the possible splits on the variable to be linear.

Choice of tuning parameters. The proposed iterative “Part Reg” process disclosed above involves two tuning parameters: the minimum node size n₀ and number of final partitions M. In theory, one can start with a candidate set of values for the two tuning parameters (n₀, M), and then use K-fold cross-validation to choose the best tuning parameter. Here, the number of combinations might be large, which adds to the computational complexity. Example implementations fix the minimum node size at some reasonable value depending on the application and sample size, and then choose the number of terminal nodes by the risk measure on a test sample. Let (s′ᵢ,x′ᵢ,yᵢ), i=n+1, . . . , N denote the observations in the test data, and (\hat{β}ₘ,Ĉₘ) denote the estimate regression coefficients and partitions from training sample and M denote the set of tree sizes that are searched through, then M is chosen by minimizing the out-sample least squares,

$${M}^{⋒} = {arg min}_{M ∈ ℳ} {\sum }_{i = n + 1}^{N} {( {y}_{i} - {\sum }_{m = 1}^{M} {x}_{i}^{′} {\hat{β}}_{m} {I}_{( {s}_{i} ∈ {C}_{m} )} )}^{2} . \qquad ( 8 )$$

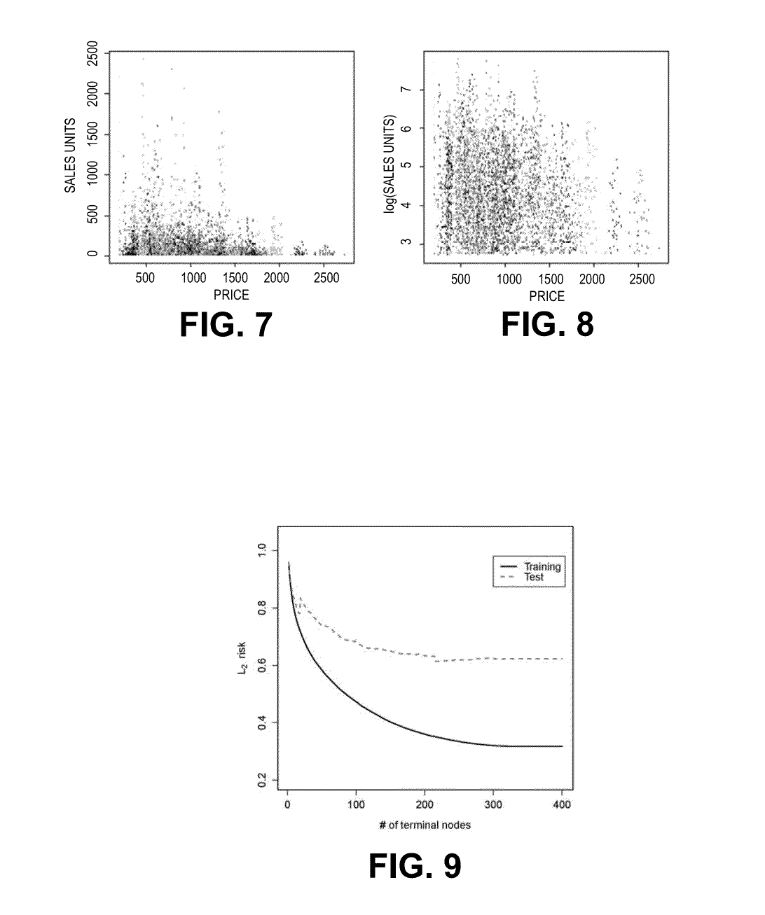

As noted above, the varying-coefficient linear model is used in predicting demand in certain implementations of the system 10. In one example implementation, sales units and log-transformed sales units are plotted against price as illustrated in FIG. 7 and FIG. 8. The product price ranges from nearly 200 to over 2500 U.S. dollars in the illustrated example. The distribution of the untransformed sales shown in FIG. 7 is highly skewed while the marginal distribution of the log-transformed sales illustrated in FIG. 8 is more symmetric. Thus, the log-transformed variable is used as the modeling target. Let yᵢ denote the number of units sold (response variable), xᵢ denote the average selling price (predictor variable) and sᵢ denote the vector of varying-coefficient variables (partition variables), including the month, state, sales channel and laptop features. The model is

log(yᵢ)=β₀(sᵢ)+β₁(sᵢ)xᵢ+εᵢ, (9)

which is estimated via the tree-based method. The minimum node size in the tree model is fixed at n₀=10. The tuning parameters M are chosen by minimizing the squared error loss on a test sample. The L₂ risk on training and test sample is plotted in FIG. 9, where the solid line represents the L₂ risk on training data and the dashed line represents the L₂ risk on test data

The disclosed methods and systems primarily focus on varying-coefficient linear regression estimated with a least squares criterion. However, the methodology is readily generalized to nonlinear and generalized linear models, with a wide range of loss functions. More robust loss functions, or likelihood-based criteria for non-Gaussian data are also appropriate.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system, comprising:
a processor;
a memory storing parent node data accessible by the processor;
wherein the processor is configured to split the parent node data into first and second child nodes based on a first partition variable to create a tree-based model; and create a first regression model for the first child node data relating a response variable and a predictor variable.

2. The system of claim 1, wherein the processor is configured to split the data of the second child node into third and fourth child nodes based on a second partition variable; and to create a second regression model for the third child node data relating the response variable and the predictor variable.

3. The system of claim 1, wherein the processor is configured to select the first partition variable from a plurality of partition variables based on a relationship between the first partition variable, the response variable and the predictor variable.

4. The system of claim 1, wherein the processor is configured to evaluate a plurality of possible splits of the parent node data.

5. The system of claim 4, wherein evaluating includes:
creating a parent node regression model for the parent node data;
determining a parent node error value for the parent regression model;
determining a first error value for the first regression model;
creating a second regression model for the second child node data;
determining a second error value for the second regression model; and
comparing the parent node error value to the first and second error values.

7. The system of claim 1, wherein the processor is configured to determine a desired number of terminal nodes based on a mathematical criterion.

8. The system of claim 1, wherein the response variable is product demand, the predictor variable is product price and the partition variable is the first product attribute, and wherein the processor is configured to:
select one of the first or second child nodes based on the first product attribute;
if the first child node is selected, then predict product demand based on the product price using the first regression model.

9. A method, comprising:
providing parent node data;
specifying a response variable;
specifying a predictor variable;
determining a first partition variable;
splitting the parent node data into first and second child nodes based on the first partition variable to create a tree-based model by a processor;
creating a first regression model for the first child node data relating the response variable and the predictor variable by a processor.

10. The method of claim 9, further comprising:
specifying a second partition variable;
splitting the data of the second child node into third and fourth child nodes based on the second partition variable; and
creating a second regression model for the third child node data relating the response variable and the predictor variable.

11. The method of claim 9, further comprising selecting the first partition variable from a plurality of partition variables based on a relationship between the first partition variable and the response variable.

12. The method of claim 9, wherein splitting the data includes evaluating a plurality of possible splits for the first partition variable.

13. The method of claim 12, wherein evaluating includes:
creating a parent node regression model for the parent node data;
determining a parent node error value for the parent regression model;
determining a first error value for the first regression model;
creating a second regression model for the second child node data;
determining a second error value for second regression model; and
comparing the parent node error value to the first and second error values.

14. The method of claim 9, further comprising determining a desired number of terminal nodes.

15. The method of claim 9, wherein the response variable is product demand, the predictor variable is product price and the partition variable is the first product attribute, and wherein the method further comprises:
selecting one of the first or second child nodes based on the first product attribute;
if the first child node is selected, then predicting product demand based on the product price using the first regression model.

16. A tangible data storage medium including program instructions for a method, comprising:
providing parent node data;
specifying a response variable;
specifying a predictor variable;
determining a first partition variable;
splitting the parent node data into first and second child nodes based on the first partition variable to create a tree-based model;
creating a first regression model for the first child node data relating the response variable and the predictor variable.

17. The storage medium of claim 16, further comprising:
specifying a second partition variable;
splitting the data of the second child node into third and fourth child nodes based on the second partition variable; and
creating a second regression model for the third child node data relating the response variable and the predictor variable.

18. The storage medium of claim 16, further comprising:
creating a parent node regression model for the parent node data;
determining a parent node error value for the parent regression model;
determining a first error value for the first regression model;
creating a second regression model for the second child node data;
determining a second error value for second regression model; and
comparing the parent node error value to the first and second error values.

19. The storage medium of claim 16, further comprising determining a desired number of terminal nodes.

20. The storage medium of claim 16, wherein the response variable is product demand, the predictor variable is product price and the partition variable is a first product attribute, and wherein the method further comprises:
selecting one of the first or second child nodes based on the first product attribute;
if the first child node is selected, then predicting product demand based on the product price using the first regression model.
